(19) United States
(12) Patent Application Publication
(10) Pub. No.: US 2014/0124205 A1
(43) Pub. Date: May 8, 2014

(54) PROCESS TO FRACTURE A SUBTERRANEAN FORMATION USING A CHELATING AGENT

(71) Applicants: Hisham Nasr-El-Din, College Station, TX (US); Mohamed Ahmed Nasr-El-Din Mahmoud, Dhahran (SA); Cornelia Adriana De Wolf, Eerbeek (NL); Jia He, College Station, TX (US)

(72) Inventors: Hisham Nasr-El-Din, College Station, TX (US); Mohamed Ahmed Nasr-El-Din Mahmoud, Dhahran (SA); Cornelia Adriana De Wolf, Eerbeek (NL); Jia He, College Station, TX (US)

(73) Assignee: AKZO NOBEL CHEMICALS INTERNATIONAL B.V., Amersfoort (NL)

(21) Appl. No.: 14/124,924

(22) PCT Filed: Jun. 11, 2012
(86) PCT No.: PCT/EP2012/060951

§ 371 Date: Dec. 9, 2013

Related U.S. Application Data
(60) Provisional application No. 61/496,214, filed on Jun. 13, 2011.

(30) Foreign Application Priority Data
Jul. 6, 2011 (EP) 11172814.3

(51) Int. Cl. C09K 8/72; C09K 8/60; E21B 43/16

(52) U.S. Cl. CPC C09K 8/72; E21B 43/16; C09K 8/60
USPC 166/307

(57) ABSTRACT

The present invention relates to a process for fracturing a subterranean formation comprising a step of fracturing the formation and a step of introducing a treatment fluid containing glutamic acid N,N-diacetic acid or a salt thereof (GLDA), methylglycine N,N-diacetic acid or a salt thereof (MGDA) and/or N-hydroxyethyl ethylenediamine N,N′,N′-triacetic acid or a salt thereof (HEDTA) into the formation, wherein the fracturing step can take place before introducing the treatment fluid into the formation, while introducing the treatment fluid into the formation or subsequent to introducing the treatment fluid into the formation.

The present invention relates to a process for fracturing subterranean formations with a treatment fluid that contains glutamic acid N,N-diacetic acid or a salt thereof (GLDA), N-hydroxyethyl ethylenediamine N,N′,N′-triacetic acid or a salt thereof (HEDTA) and/or methylglycine N,N diacetic acid or a salt thereof (MGDA).

Subterranean formations from which oil and/or gas can be recovered can contain several solid materials contained in porous or fractured rock formations. The naturally occurring hydrocarbons, such as oil and/or gas, are trapped by the overlying rock formations with lower permeability. The reservoirs are found using hydrocarbon exploration methods and often one of the treatments needed to withdraw the oil and/or gas therefrom is to improve the permeability of the formations. The rock formations can be distinguished by their major components.

One process to make formations like carbonate or sandstone formations more permeable is an acidic fracturing process, wherein an acidic fluid is introduced into the formations trapping the oil and/or gas under a pressure that is high enough to fracture the rock, the acidic fluid meanwhile or afterwards dissolving the carbonate so that the fracture does not fully close anymore once the pressure is released again.

GB 2420577 discloses a fracturing fluid containing a choline salt and a viscosifier. It is said that scale control additives may be added, which can be a chelating agent like for example a salt of EDTA or NTA.

In the Handbook Oil Field Chemicals of 2003, published by Elsevier Inc., Chapter 17, “Hydraulic Fracturing Fluids,” pp. 233-275, it is explained that acidic fracturing fluids for a good functionality in the application of treating subterranean formations should have a low fluid loss to enable them to sufficiently acidize the fracture surface of the formation after having fractured it and so create a continued permeability of the rock even after the pressure is lowered again. In acid fracturing it is an additional objective to make the time until the acid is spent is as long as possible, in order that the formation can react longer and more deeply with the acid and the permeability is increased. Apart from that, it is important to ensure complete acid spending, which will also result in better fracture conductivity.

M. Pournik, M. Mahmoud, H. A. Nasr-El-Din in “A novel application of closed fracture acidizing” presented at the SPE Annual Technical Conference and Exhibition, New Orleans, La., USA Oct. 4-7, 2009, and later published as SPE 124874, disclose the use of gelled acid in acid fracturing. The material used is based on HCl. A similar disclosure was made by M. Pournik et al, in “Small-scale fracture conductivity created by modern acid-fracture fluids” presented at the SPE Hydraulic Fracturing Technology Conference in College Station, Texas, USA Jan. 29-31, 2007 and later published as SPE 106272. This document in addition describes a trend of decreasing rock embedment strength after acid injection for three types of HCl systems: gelled, emulsified and with a viscoelastic surfactant for identical Indiana limestone cores. According to this document the temperature during acid injection has only a minor effect on the rock strength whereas the duration of the acid injection has a major impact on the rock strength. It is in addition disclosed that longer acid contact times weaken the rock to a much higher extent.

The main concern about the use of HCl in acid fracturing is the fluid loss, besides the problems of undesired corrosion and undesired side effects caused by iron available in the subterranean system. The fluid loss is caused by the high reactivity of HCl with the rock formation, resulting in the loss of fluid in the direction perpendicular to the fracture direction. As a result no HCl is available to treat the fracture surface further away from the wellbore, leading to a less effective acid fracturing treatment, an increased chemical usage, an increased risk to the environment, and ultimately an inadequate production of oil and/or gas. Polymers or surfactants are added to HCl to reduce fluid leak-off and diffusion. After fracturing the viscosity of the fracturing fluids needs to be lowered to remove the fluid from the fracture and enable the well to start producing the oil or gas. Unsuccessful removal of the fracturing fluids leads to formation damage, hence there is a need for acid fracturing fluids that do not require such a step. In addition, it has been established that HCl treatments weaken the rock structure, leading to closure of the open fractures formed by the acid fracturing treatment at lower closure pressures, hence there is a need for acid fracturing fluids that do not soften the rock around the fracture.

An effective treatment fluid should be compatible with asphaltenes, prevent iron precipitation, be compatible with the clays, dissolve carbonates and other inorganic components, and so help to create a high permeability rock even after the hydraulic pressure is released.

The present invention aims to provide a process in which many of the above attendant disadvantages of the state of the art are avoided and which leads to the benefits as indicated above.

It has been found that when using a fluid for the formation treatment in which GLDA, MGDA and/or HEDTA are used, the above disadvantages are avoided to a great extent and there are further improvements in producing oil and/or gas by a fracturing process.

Accordingly, the present invention provides a process for treating a subterranean formation comprising a step of fracturing the formation and a step of introducing a treatment fluid containing glutamic acid N,N-diacetic acid or a salt thereof (GLDA), methylglycine N,N diacetic acid or a salt thereof (MGDA) and/or N-hydroxyethyl ethylenediamine N,N′,N′-triacetic acid or a salt thereof (HEDTA) into the formation, wherein the fracturing step can take place before introducing the fluid into the formation, while introducing the fluid into the formation or subsequent to introducing the fluid into the formation.

If fracturing takes place while introducing the treatment fluid into the formation, the treatment fluid containing GLDA, MGDA and/or HEDTA can function as both the treatment and the fracturing fluid and will be introduced into the formation under a pressure above the fracture pressure of the treated formation. In this way, the process has a real economic benefit as instead of two fluids, only one fluid needs to be used.

In addition, the above process can be used in acid refracturing of oil and gas wells previously fractured by HCl or another material.

It has now been established that without any additives GLDA, MGDA, and HEDTA have low diffusion compared to HCl. GLDA, MGDA, and HEDTA are low-reactive by nature and give rise to lower fluid loss. In addition, it has been found that when using GLDA, MGDA, and HEDTA in acidic fracturing, there is a reduced need for viscosifying additives (polymers, surfactants), friction reducers, iron control, sludge control and corrosion inhibitors, and viscosity breakers. Furthermore, it was surprisingly found that GLDA, MGDA, and HEDTA do give a large improvement in reducing the undesired weakening or softening of the rock formations that generally finds place during acid fracturing processes.

It was found that the fracturing step gives the fluid a better flow through the formation, and makes it possible for a higher area of the formation to be treated with the treatment fluid containing GLDA, MGDA and/or HEDTA, thus enabling a higher oil and/or gas production from the formation. In addition, the treatment fluid containing GLDA, MGDA and/or HEDTA was found to be very suitable for recycling fracturing fluid and transporting particles, fines, deposits created by fracturing the formation. For example, the treatment fluid containing GLDA, MGDA and/or

HEDTA was found to be useful in keeping the fractures formed by the fracturing step open and in addition capable of transporting any particles, fines, deposits outside the formation, while at the same time it was found to be capable of creating further channels into the formation as well as etched surfaces thereon by dissolving certain acid-soluble constituents, like carbonates, in the formation. In addition, compared to conventional acids like HCl, they give less undesired side-effects caused by clays that are often present in formations, especially in sandstone formations, such as the undesired blocking of just formed fractures.

In a preferred embodiment the subterranean formation is a carbonate (calcite, chalk or dolomite) or carbonate-containing, like a carbonate-containing sandstone, formation.

Moreover, it was found that the treatment fluids of the invention are very suitable for desorbing the gas and/or oil from the formation and are additionally compatible to a high extent with the crude oil and/or gas.

In addition, the treatment fluids of the present invention require much lower amounts of—and sometimes can even do without—certain additives, like especially antisludge additives, fluid loss additives, clay stabilizers, viscosifiers, thickeners, iron control agents, corrosion inhibitors, and corrosion inhibitor intensifiers. Especially when the treatment fluids of the present invention have a low pH, they need significantly lower amounts of these additives while having the same effectiveness.

The term treating in this application is intended to cover any treatment of the fractured formation with the treatment fluid. It specifically covers treating the formation with the treatment fluid wherein the fluid is allowed to contact the surfaces of the subterranean formation in the fractured zones, to change at least part of these surfaces, to create an inhomogeneous fracture surface, to remove small particles and fines from the fractures, and/or to prevent the fractures from completely closing immediately when the fracture pressure is released to achieve at least one of (i) an increased permeability or conductivity, (ii) the removal of small particles, and (iii) the removal of inorganic scale, and so ultimately enhance the well performance and enable an increased production of oil and/or gas from the fractured formation. At the same time it may in addition cover cleaning of the wellbore and descaling of the oil/gas production well and production equipment.

In this respect, it should be noted that US 2006/0073984 discloses a fracturing fluid containing a chelating agent chosen from a group of alternatives, such as for example HEDTA, that serves as a shale hydration inhibition agent, an agent that prevents a fractured shale formation to swell. Nowhere in this document is it disclosed or suggested that the fluid described therein that may contain HEDTA serves to treat the fractured formation as defined above. In addition, this document does not contain any hint to choose HEDTA from the list of alternatives disclosed.

WO 2009/086954 discloses the good solubility of GLDA in acidic solutions. Because of this good solubility, the document discloses the use of GLDA as a chemical in the oil field, for example in a fracturing process. However, this document does not disclose a process to treat a subterranean formation comprising an explicit fracturing step and a treatment of the fractured zone in the subterranean formation with a fluid containing GLDA to achieve a treatment of the formation, i.e. to change at least part of the fractured surfaces, to remove small particles and fines from the fractures, and/or to prevent the fractures from completely closing immediately when the fracture pressure is released. Also in this document no suggestion is made that a fluid containing GLDA would be capable of achieving any of the above.

It can in addition be noted that WO 2008/015464 discloses a fluid that may contain a chelating agent and/or a scale control agent, mainly to remediate surfactant gel damage, but also to be used in many other applications, such as to remediate a formation that has been previously treated with, for example, a fracturing fluid, or acidizing treatment. The chelating agents may be chosen from a group of several compounds, with EDTA the only chelating agent being exemplified and this only to demonstrate a permeability regaining effect in relation to an oleamidopropyl betaine viscoelastic surfactant. Accordingly, the document does not clearly and unambiguously disclose the use of a fluid containing GLDA, MGDA or HEDTA as a treatment fluid in a fracturing process, nor the advantageous effects of the present invention.

Surprisingly, it was found that GLDA, MGDA and/or HEDTA do not degrade sandstone formations to give many small particles, as is the case with acidic treatment fluids that are based on other acids like HCl. GLDA, MGDA and/or HEDTA act much more selectively on the carbonate in the formation and dissolve this carbonate material, leaving the other constituents in the formation quite unaffected. Therefore, when using the process of the invention, the disadvantages caused by many fines, which are primarily to do with fines migration causing particles suspended in the produced fluid to bridge the pore throats near the wellbore, and so reducing well productivity, can be largely avoided. Damage created by fines usually is located within a radius of 3 to 5 ft [1 to 2 m] of the wellbore, but can also occur in gravel-pack completions. In addition, the process of the invention provides an improved permeability of the formation.

As a further benefit it was found that the treatment fluids of the present invention, which in many embodiments are water-based, perform as well in an oil saturated environment as in an aqueous environment. This can only lead to the conclusion that the fluids of the invention are compatible with (crude) oil.

The GLDA, MGDA and/or HEDTA are preferably used in an amount of between 5 and 40 wt %, more preferably between 10 and 30 wt %, even more preferably between 10 and 20 wt %, on the basis of the total weight of the treatment fluid. These highly concentrated solutions are suitable because when you perform a fracturing step in a well, a high amount of calcite needs to be dissolved in a short time and that can be achieved by using high concentrations. Another benefit of a highly concentrated solution is that because of the higher viscosity of the more concentrated solutions, a lower leak-off takes place.

Because preparing highly concentrated fluids of GLDA with many other constituents is easier than in the case of MGDA and HEDTA over a broad pH range, GLDA is preferred. As can be read in WO 2009/086954, GLDA is much better soluble in many aqueous and acidic solutions.

Salts of GLDA, MGDA and/or HEDTA that can be used are their alkali metal, alkaline earth metal, or ammonium full and partial salts. Also mixed salts containing different cations can be used. Preferably, the sodium, potassium, lithium, cesium and ammonium full or partial salts of GLDA, MGDA and/or HEDTA are used.

In a preferred embodiment GLDA is used, as this material gives clearly the best results.

The treatment fluids of the invention are preferably aqueous fluids, i.e. they preferably contain water as a solvent for the other ingredients, though other solvents may be added as well, as also further explained below.

The pH of the treatment fluids of the invention can range from 1.7 to 14. Preferably, however, it is between 3 and 13, as in the very acidic ranges of 1.7 to 3 and the very alkaline range of 13 to 14 some undesired side effects may be caused by the fluids in the formation, such as too fast dissolution of carbonate giving excessive CO₂ formation or an increased risk of reprecipitation. For a better carbonate dissolving capacity it is preferably acidic. On the other hand, it must be realized that highly acidic solutions are more expensive. Consequently, the treatment fluids even more preferably have a pH of 3 to 6.

The treatment fluid may contain other additives that improve the functionality of the stimulation action and minimize the risk of damage as a consequence of the said treatment, as is known to anyone skilled in the art.

The treatment fluid of the invention may in addition contain one or more of the group of anti-sludge agents, surfactants, corrosion inhibitors, mutual solvents, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives such as further acids and/or bases, bactericides/biocides, particulates, crosslinkers, salt substitutes (such as tetramethyl ammonium chloride), relative permeability modifiers, sulfide scavengers, fibres, nanoparticles, consolidating agents (such as resins and/or tackifiers), combinations thereof, or the like.

The mutual solvent is a chemical liquid additive that is soluble in oil, water, acids (often HCl based), and other well treatment fluids, (see also http://www.glossary.oilfield.slb.com). In many cases the mutal solvent makes that the oil and water based liquids which are ordinarily immiscible liquids combine with each other, and in preferred embodiments form a clear solution. Mutual solvents are routinely used in a range of applications, controlling the wettability of contact surfaces before, during and/or after a treatment, and preventing or breaking emulsions. Mutual solvents are used, as insoluble formation fines pick up organic film from crude oil. These particles are partially oil-wet and partially water-wet. This causes them to collect materials at any oil-water interface, which can stabilize various oil-water emulsions. Mutual solvents remove organic films leaving them water-wet, thus emulsions and particle plugging are eliminated. If a mutual solvent is employed, it is preferably selected from the group which includes, but is not limited to, lower alcohols such as methanol, ethanol, 1-propanol, 2-propanol, and the like, glycols such as ethylene glycol, propylene glycol, diethylene glycol, dipropylene glycol, polyethylene glycol, polypropylene glycol, polyethylene glycol-polyethylene glycol block copolymers, and the like, and glycol ethers such as 2-methoxyethanol, diethylene glycol monomethyl ether, and the like, substantially water/oil-soluble esters, such as one or more C2-esters through C10-esters, and substantially water/oil-soluble ketones, such as one or more C2-C10 ketones. The mutual solvent is preferably present in an amount of 1 to 50 wt % on total fluid.

A preferred water/oil-soluble ketone is methyl ethyl ketone.

A preferred substantially water/oil-soluble alcohol is methanol.

A preferred substantially water/oil-soluble ester is methyl acetate.

A more preferred mutual solvent is ethylene glycol monobutyl ether, generally known as EGMBE.

The amount of glycol solvent in the solution is preferably about 1 wt % to about 10 wt %, more preferably between 3 and 5 wt %. More preferably, the ketone solvent may be present in an amount from 40 wt % to about 50 wt %; the substantially water-soluble alcohol may be present in an amount within the range of about 20 wt % to about 30 wt %; and the substantially water/oil-soluble ester may be present in an amount within the range of about 20 wt % to about 30 wt %, each amount being based upon the total weight of the solvent in the fluid.

In one embodiment the mutual solvent can be used as a preflush or postflush material, i.e. in such embodiment it will be introduced into the formation before or after the treatment with the fracturing/treatment fluid.

The surfactant can be any surfactant known in the art and can be nonionic, cationic, anionic, and zwitterionic. When the formation is a sandstone formation, preferably the surfactant is nonionic or anionic. Even more preferably, the surfactant is anionic. When the formation is a carbonate formation, preferably the surfactant is cationic or nonionic.

The nonionic surfactant of the present composition is preferably selected from the group consisting of alkanolamides, alkoxylated alcohols, alkoxylated amines, amine oxides, alkoxylated amides, alkoxylated fatty acids, alkoxylated fatty amines, alkoxylated alkyl amines (e.g., cocoalkyl amine ethoxylate), alkyl phenyl polyethoxylates, lecithin, hydroxylated lecithin, fatty acid esters, glycerol esters and their ethoxylates, glycol esters and their ethoxylates, esters of propylene glycol, sorbitan, ethoxylated sorbitan, polyglycosides and the like, and mixtures thereof. Alkoxylated alcohols, preferably ethoxylated alcohols, optionally in combination with (alkyl)polyglycosides, are the most preferred nonionic surfactants.

The anionic (sometimes zwitterionic, as two charges are combined into one compound) surfactants may comprise any number of different compounds, including sulfonates, hydrolyzed keratin, sulfosuccinates, taurates, betaines, modified betaines, alkylamidobetaines (e.g., cocoamidopropyl betaine).

The cationic surfactants may comprise quaternary ammonium compounds (e.g., trimethyl tallow ammonium chloride, trimethyl coco ammonium chloride), derivatives thereof, and combinations thereof.

Examples of surfactants that are also foaming agents that may be utilized to foam and stabilize the treatment fluids of this invention include, but are not limited to, betaines, amine oxides, methyl ester sulfonates, alkylamidobetaines such as cocoamidopropyl betaine, alpha-olefin sulfonate, trimethyl tallow ammonium chloride, C8 to C22 alkyl ethoxylate sulfate, and trimethyl coco ammonium chloride.

Suitable surfactants may be used in a liquid or powder form.

Where used, the surfactants may be present in the fluid in an amount sufficient to prevent incompatibility with formation fluids, other treatment fluids, or wellbore fluids at reservoir temperature.

In an embodiment where liquid surfactants are used, the surfactants are generally present in an amount in the range of from about 0.01% to about 5.0% by volume of the fluid.

In one embodiment, the liquid surfactants are present in an amount in the range of from about 0.1% to about 2.0% by volume of the fluid, more preferably between 0.1 and 1 volume %.

In embodiments where powdered surfactants are used, the surfactants may be present in an amount in the range of from about 0.001% to about 0.5% by weight of the fluid.

The antisludge agent can be chosen from the group of mineral and/or organic acids used to stimulate sandstone hydrocarbon bearing formations. The function of the acid is to dissolve acid-soluble materials so as to clean or enlarge the flow channels of the formation leading to the wellbore, allowing more oil and/or gas to flow to the wellbore.

Problems are caused by the interaction of the (usually concentrated, 20-28% HCl) stimulation acid and certain crude oils (e.g. asphaltic oils) in the formation to form sludge. Interaction studies between sludging crude oils and the introduced acid show that permanent rigid solids are formed at the acid-oil interface when the aqueous phase is below a pH of about 4. No films are observed for non-sludging crudes with acid.

These sludges are usually reaction products formed between the acid and the high molecular weight hydrocarbons such as asphaltenes, resins, etc.

Methods for preventing or controlling sludge formation with its attendant flow problems during the acidization of crude-containing formations include adding “anti-sludge” agents to prevent or reduce the rate of formation of crude oil sludge, which anti-sludge agents stabilize the acid-oil emulsion and include alkyl phenols, fatty acids, and anionic surfactants. Frequently used as the surfactant is a blend of a sulfonic acid derivative and a dispersing surfactant in a solvent. Such a blend generally has dodecyl benzene sulfonic acid (DDBSA) or a salt thereof as the major dispersant, i.e. anti-sludge, component.

The carrier fluids are aqueous solutions which in certain embodiments contain a Bronsted acid to keep the pH in the desired range and/or contain an inorganic salt, preferably NaCl or KCl.

Corrosion inhibitors may be selected from the group of amine and quaternary ammonium compounds and sulfur compounds. Examples are diethyl thiourea (DETU), which is suitable up to 185° F. (about 85° C.), alkyl pyridinium or quinolinium salt, such as dodecyl pyridinium bromide (DDPB), and sulfur compounds, such as thiourea or ammonium thiocyanate, which are suitable for the range 203-302° F. (about 95-150° C.), benzotriazole (BZT), benzimidazole (BZI), dibutyl thiourea, a proprietary inhibitor called TIA, and alkyl pyridines.

In general, the most successful inhibitor formulations for organic acids and chelating agents contain amines, reduced sulfur compounds or combinations of a nitrogen compound (amines, quats or polyfunctional compounds), and a sulfur compound. The amount of corrosion inhibitor is preferably less than 2 volume %, more preferably between 0.01 and 1 volume %, even more preferably between 0.1 and 1 volume % on total fluid volume.

One or more corrosion inhibitor intensifiers may be added, such as for example formic acid, potassium iodide, antimony chloride, or copper iodide.

One or more salts may be used as rheology modifiers to modify the rheological properties (e.g., viscosity and elastic properties) of the treatment fluids. These salts may be organic or inorganic.

Examples of suitable organic salts include, but are not limited to, aromatic sulfonates and carboxylates (such as p-toluene sulfonate and naphthalene sulfonate), hydroxynaphthalene carboxylates, salicylate, phthalate, chlorobenzoic acid, phthalic acid, 5-hydroxy-1-naphthoic acid, 6-hydroxy-1-naphthoic acid, 7-hydroxy-1-naphthoic acid, 1-hydroxy-2-naphthoic acid, 3-hydroxy-2-naphthoic acid, 5-hydroxy-2-naphthoic acid, 7-hydroxy-2-naphthoic acid, 1,3-dihydroxy-2-naphthoic acid, 3,4-dichlorobenzoate, trimethyl ammonium hydrochloride and tetramethyl ammonium chloride.

Examples of suitable inorganic salts include water-soluble potassium, sodium, and ammonium halide salts (such as potassium chloride and ammonium chloride), calcium chloride, calcium bromide, magnesium chloride, sodium formate, potassium formate, cesium formate, and zinc halide salts. A mixture of salts may also be used, but it should be noted that preferably chloride salts are mixed with chloride salts, bromide salts with bromide salts, and formate salts with formate salts.

Wetting agents that may be suitable for use in this invention include crude tall oil, oxidized crude tall oil, surfactants, organic phosphate esters, modified imidazolines and amidoamines, alkyl aromatic sulfates and sulfonates, and the like, and combinations or derivatives of these and similar such compounds that should be well known to one of skill in the art.

The foaming gas may be air, nitrogen or carbon dioxide. Nitrogen is preferred.

Gelling agents in a preferred embodiment are polymeric gelling agents.

Examples of commonly used polymeric gelling agents include, but are not limited to, biopolymers, polysaccharides such as guar gums and derivatives thereof, cellulose derivatives, synthetic polymers like polyacrylamides and viscoelastic surfactants, and the like. These gelling agents, when hydrated and at a sufficient concentration, are capable of forming a viscous solution.

When used to make an aqueous-based treatment fluid, a gelling agent is combined with an aqueous fluid and the soluble portions of the gelling agent are dissolved in the aqueous fluid, thereby increasing the viscosity of the fluid.

Viscosifiers may include natural polymers and derivatives such as xantham gum and hydroxyethyl cellulose (HEC) or synthetic polymers and oligomers such as poly(ethylene glycol) [PEG], poly(diallyl amine), poly(acrylamide), poly(amino-methyl propyl sulfonate) [AMPS polymer], poly(acrylonitrile), poly(vinyl acetate), poly(vinyl alcohol), poly(vinyl amine), poly(vinyl sulfonate), poly(styryl sulfonate), poly(acrylate), poly(methyl acrylate), poly(methacrylate), poly(methyl methacrylate), poly(vinyl pyrrolidone), poly(vinyl lactam) and co-, ter-, and quarter-polymers of the following (co-)monomers: ethylene, butadiene, isoprene, styrene, divinyl benzene, divinyl amine, 1,4-pentadiene-3-one (divinyl ketone), 1,6-heptadiene-4-one (diallyl ketone), diallyl amine, ethylene glycol, acrylamide, AMPS, acrylonitrile, vinyl acetate, vinyl alcohol, vinyl amine, vinyl sulfonate, styryl sulfonate, acrylate, methyl acrylate, methacrylate, methyl methacrylate, vinyl pyrrolidone, and vinyl lactam. Yet other viscosifiers include clay-based viscosifiers, especially laponite and other small fibrous clays such as the polygorskites (attapulgite and sepiolite). When using polymer-containing viscosifiers, the viscosifiers may be used in an amount of up to 5% by weight of the fluid.

Examples of suitable brines include calcium bromide brines, zinc bromide brines, calcium chloride brines, sodium chloride brines, sodium bromide brines, potassium bromide brines, potassium chloride brines, sodium nitrate brines, sodium formate brines, potassium formate brines, cesium formate brines, magnesium chloride brines, sodium sulfate, potassium nitrate, and the like. A mixture of salts may also be used in the brines, but it should be noted that preferably chloride salts are mixed with chloride salts, bromide salts with bromide salts, and formate salts with formate salts.

The brine chosen should be compatible with the formation and should have a sufficient density to provide the appropriate degree of well control.

Additional salts may be added to a water source, e.g., to provide a brine, and a resulting treatment fluid, in order to have a desired density.

The amount of salt to be added should be the amount necessary for formation compatibility, such as the amount necessary for the stability of clay minerals, taking into consideration the crystallization temperature of the brine, e.g., the temperature at which the salt precipitates from the brine as the temperature drops.

Preferred suitable brines may include seawater and/or formation brines.

Salts may optionally be included in the fluids of the present invention for many purposes, including for reasons related to compatibility of the fluid with the formation and the formation fluids.

To determine whether a salt may be beneficially used for compatibility purposes, a compatibility test may be performed to identify potential compatibility problems.

From such tests, one of ordinary skill in the art will, with the benefit of this disclosure, be able to determine whether a salt should be included in a treatment fluid of the present invention.

Suitable salts include, but are not limited to, calcium chloride, sodium chloride, magnesium chloride, potassium chloride, sodium bromide, potassium bromide, ammonium chloride, sodium formate, potassium formate, cesium formate, and the like. A mixture of salts may also be used, but it should be noted that preferably chloride salts are mixed with chloride salts, bromide salts with bromide salts, and formate salts with formate salts.

The amount of salt to be added should be the amount necessary for the required density for formation compatibility, such as the amount necessary for the stability of clay minerals, taking into consideration the crystallization temperature of the brine, e.g., the temperature at which the salt precipitates from the brine as the temperature drops.

Salt may also be included to increase the viscosity of the fluid and stabilize it, particularly at temperatures above 180° F. (about 82° C.).

Examples of suitable pH control additives which may optionally be included in the treatment fluids of the present invention are acid compositions and/or bases.

A pH control additive may be necessary to maintain the pH of the treatment fluid at a desired level, e.g., to improve the effectiveness of certain breakers and to reduce corrosion on any metal present in the wellbore or formation, etc.

One of ordinary skill in the art will, with the benefit of this disclosure, be able to recognize a suitable pH for a particular application.

In one embodiment, the pH control additive may be an acid composition.

Examples of suitable acid compositions may comprise an acid, an acid-generating compound, and combinations thereof.

Any known acid may be suitable for use with the treatment fluids of the present invention.

Examples of acids that may be suitable for use in the present invention include, but are not limited to, organic acids (e.g., formic acids, acetic acids, carbonic acids, citric acids, glycolic acids, lactic acids, ethylene diamine tetraacetic acid (EDTA), and the like), inorganic acids (e.g., hydrochloric acid, hydrofluoric acid, phosphonic acid, p-toluene sulfonic acid, and the like), and combinations thereof. Preferred acids are HCl (to an amount compatible with the illite content) and organic acids. Examples of acid-generating compounds that may be suitable for use in the present invention include, but are not limited to, esters, aliphatic polyesters, ortho esters, which may also be known as ortho ethers, poly(ortho esters), which may also be known as poly(ortho ethers), poly(lactides), poly(glycolides), poly(epsilon-caprolactones), poly(hydroxybutyrates), poly(anhydrides), or copolymers thereof.

Derivatives and combinations also may be suitable.

The term “copolymer” as used herein is not limited to the combination of two polymers, but includes any combination of polymers, e.g., terpolymers and the like.

Other suitable acid-generating compounds include: esters including, but not limited to, ethylene glycol monoformate, ethylene glycol diformate, diethylene glycol diformate, glyceryl monoformate, glyceryl diformate, glyceryl triformate, methylene glycol diformate, and formate esters of pentaerythritol.

The pH control additive also may comprise a base to elevate the pH of the fluid.

Generally, a base may be used to elevate the pH of the mixture to greater than or equal to about 7.

Having the pH level at or above 7 may have a positive effect on a chosen breaker being used and may also inhibit the corrosion of any metals present in the wellbore or formation, such as tubing, screens, etc.

In addition, having a pH greater than 7 may also impart greater stability to the viscosity of the treatment fluid, thereby enhancing the length of time that viscosity can be maintained.

This could be beneficial in certain uses, such as in longer-term well control and in diverting.

Any known base that is compatible with the gelling agents of the present invention can be used in the fluids of the present invention.

Examples of suitable bases include, but are not limited to, sodium hydroxide, potassium carbonate, potassium hydroxide, sodium carbonate, and sodium bicarbonate.

One of ordinary skill in the art will, with the benefit of this disclosure, recognize the suitable bases that may be used to achieve a desired pH elevation.

In some embodiments, the treatment fluid may optionally comprise a further chelating agent.

When added to the treatment fluids of the present invention, the chelating agent may chelate any dissolved iron (or other divalent or trivalent cation) that may be present in the aqueous fluid and prevent any undesired reactions being caused.

Such chelating agent may e.g. prevent such ions from crosslinking the gelling agent molecules.

Such crosslinking may be problematic because, inter alia, it may cause filtration problems, injection problems, and/or cause permeability problems once more.

Any suitable chelating agent may be used with the present invention.

Examples of suitable chelating agents include, but are not limited to, citric acid, nitrilotriacetic acid (“NTA”), any form of ethylene diamine tetraacetic acid (EDTA), diethylene triamine pentaacetic acid (DTPA), propylene diamine tetraacetic acid (PDTA), ethylene diamine-N,N″-di(hydroxyphenylacetic)acid (EDDHA), ethylene diamine-N,N″-di-(hydroxy-methylphenyl acetic acid (EDDH MA), ethanol diglycine (EDG), trans-1,2-cyclohexylene dinitrilotetraacetic acid (CDTA), glucoheptonic acid, gluconic acid, sodium citrate, phosphonic acid, salts thereof, and the like.

In some embodiments, the chelating agent may be a sodium, potassium or ammonium salt.

Generally, the chelating agent may be present in an amount sufficient to prevent undesired side effects of divalent or trivalent cations that may be present, and thus also functions as a scale inhibitor.

One of ordinary skill in the art will, with the benefit of this disclosure, be able to determine the proper concentration of a chelating agent for a particular application.

In some embodiments, the fluids of the present invention may contain bactericides or biocides, inter alia, to protect the subterranean formation as well as the fluid from attack by bacteria. Such attacks can be problematic because they may lower the viscosity of the fluid, resulting in poorer performance, such as poorer sand suspension properties, for example.

Any bactericides known in the art are suitable. Biocides and bactericides that protect against bacteria that may attack GLDA, MGDA or HEDTA, or sulfates are preferred.

An artisan of ordinary skill will, with the benefit of this disclosure, be able to identify a suitable bactericide and the proper concentration of such bactericide for a given application.

Examples of suitable bactericides and/or biocides include, but are not limited to, phenoxyethanol, ethylhexyl glycerine, benzyl alcohol, methyl chloroisothiazolinone, methyl isothiazolinone, methyl paraben, ethyl paraben, propylene glycol, bronopol, benzoic acid, imidazolinidyl urea, a 2,2-dibromo-3-nitrilopropionamide, and a 2-bromo-2-nitro-1,3-propane diol. In one embodiment, the bactericides are present in the fluid in an amount in the range of from about 0.001% to about 1.0% by weight of the fluid.

Fluids of the present invention also may comprise breakers capable of reducing the viscosity of the fluid at a desired time.

Examples of such suitable breakers for fluids of the present invention include, but are not limited to, oxidizing agents such as sodium chlorites, sodium bromate, hypochlorites, perborate, persulfates, and peroxides, including organic peroxides.

Other suitable breakers include, but are not limited to, suitable acids and peroxide breakers, triethanol amine, as well as enzymes that may be effective in breaking. The breakers can be used as is or encapsulated.

Examples of suitable acids may include, but are not limited to, hydrochloric acid, hydrofluoric acid, formic acid, acetic acid, citric acid, lactic acid, glycolic acid, etc., and combinations of these acids.

A breaker may be included in a treatment fluid of the present invention in an amount and form sufficient to achieve the desired viscosity reduction at a desired time.

The breaker may be formulated to provide a delayed break, if desired.

The fluids of the present invention also may comprise suitable fluid loss additives. Such fluid loss additives may be particularly useful when a fluid of the present invention is used in a fracturing application or in a fluid used to seal a formation against invasion of fluid from the wellbore.

Any fluid loss agent that is compatible with the fluids of the present invention is suitable for use in the present invention.

Examples include, but are not limited to, starches, silica flour, gas bubbles (energized fluid or foam), benzoic acid, soaps, resin particulates, relative permeability modifiers, degradable gel particulates, diesel or other hydrocarbons dispersed in fluid, and other immiscible fluids.

Another example of a suitable fluid loss additive is one that comprises a degradable material.

Suitable examples of degradable materials include polysaccharides such as dextran or cellulose; chitins; chitosans; proteins; aliphatic polyesters; poly(lactides); poly(glycolides); poly(glycolide-co-lactides); poly(epsilon-caprolactones); poly(3-hydroxybutyrates); poly(3-hydroxybutyrate-co-hydroxyvalerates); poly(anhydrides); aliphatic poly(carbonates); poly(ortho esters); poly(amino acids); poly(ethylene oxides); poly(phosphazenes); derivatives thereof; or combinations thereof.

In some embodiments, a fluid loss additive may be included in an amount of about 5 to about 2,000 lbs/Mgal (about 600 to about 240,000 g/Mliter) of the fluid.

In some embodiments, the fluid loss additive may be included in an amount from about 10 to about 50 lbs/Mgal (about 1,200 to about 6,000 g/Mliter) of the fluid.

In certain embodiments, a stabilizer may optionally be included in the fluids of the present invention.

It may be particularly advantageous to include a stabilizer if a chosen fluid is experiencing viscosity degradation.

One example of a situation where a stabilizer might be beneficial is where the BHT (bottom hole temperature) of the wellbore is sufficient to break the fluid by itself without the use of a breaker.

Suitable stabilizers include, but are not limited to, sodium thiosulfate, methanol, and salts such as formate salts and potassium or sodium chloride.

Such stabilizers may be useful when the fluids of the present invention are utilized in a subterranean formation having a temperature above about 200° F. (about 93° C.). If included, a stabilizer may be added in an amount of from about 1 to about 50 lbs/Mgal (about 120 to about 6,000 g/Mliter) of fluid.

Scale inhibitors may be added to the fluids of the present invention, for example, when such fluids are not particularly compatible with the formation waters in the formation in which they are used.

These scale inhibitors may include water-soluble organic molecules with carboxylic acid, aspartic acid, maleic acids, sulfonic acids, phosphonic acid, and phosphate ester groups including copolymers, ter-polymers, grafted copolymers, and derivatives thereof.

Examples of such compounds include aliphatic phosphonic acids such as diethylene triamine penta (methylene phosphonate) and polymeric species such as polyvinyl sulfonate.

The scale inhibitor may be in the form of the free acid but is preferably in the form of mono- and polyvalent cation salts such as Na, K, Al, Fe, Ca, Mg, NH₄. Any scale inhibitor that is compatible with the fluid in which it will be used is suitable for use in the present invention.

Suitable amounts of scale inhibitors that may be included in the fluids of the present invention may range from about 0.05 to 100 gallons per about 1,000 gallons (i.e. 0.05 to 100 liters per 1,000 liters) of the fluid.

Any particulates such as proppant, gravel that are commonly used in subterranean operations in sandstone formations (e.g., sand, gravel, bauxite, ceramic materials, glass materials, wood, plant and vegetable matter, nut hulls, walnut hulls, cotton seed hulls, cement, fly ash, fibrous materials, composite particulates, hollow spheres and/or porous proppant), as well as any particulates such as fibres that are commonly used in subterranean operations in carbonate formations, may be used in the present invention, as may polymeric materials, such as polyglycolic acids and polylactic acids.

It should be understood that the term “particulate” as used in this disclosure includes all known shapes of materials including substantially spherical materials, oblong, fibre-like, ellipsoid, rod-like, polygonal materials (such as cubic materials), mixtures thereof, derivatives thereof, and the like.

In some embodiments, coated particulates may be suitable for use in the treatment fluids of the present invention. It should be noted that many particulates also act as diverting agents. Further diverting agents are viscoelastic surfactants and in-situ gelled fluids.

Oxygen scavengers may be needed to enhance the thermal stability of the GLDA, MGDA or HEDTA. Examples thereof are sulfites and ethorbates.

Friction reducers can be added in an amount of up to 0.2 vol %. Suitable examples are viscoelastic surfactants and enlarged molecular weight polymers.

Crosslinkers can be chosen from the group of multivalent cations that can crosslink polymers such as Al, Fe, B, Ti, Cr, and Zr, or organic crosslinkers such as polyethylene amides, formaldehyde.

Sulfide scavengers can suitably be an aldehyde or ketone.

Viscoelastic surfactants can be chosen from the group of amine oxides or carboxyl betaine based surfactants.

The treatment fluids can be used at basically any temperature encountered when treating a subterranean formation. Though subterranean formations normally have a temperature higher than room temperature, due to the fact that they sometimes are accessed through deep sea water, this means in practice a temperature of between 35 and 400° F. (about 2 and 204° C.). Preferably, the fluids are used at a temperature where they best achieve the desired effects, which means a temperature of between 77 and 300° F. (about 25 and 149° C.).

High temperature applications may benefit from the presence of an oxygen scavenger in an amount of less than about 2 volume % of the solution.

In the process of the invention the fluid can be flooded back from the formation. Even more preferably, (part of) the solution is recycled.

It must be realized, however, that GLDA and MGDA, being biodegradable chelating agents, will not flow back completely and therefore are not recyclable to the full extent.

Experiments

### EXAMPLE

Fracturing Indiana Limestone with 20 wt % GLDA Solution at About 130° F.

Materials. Indiana limestone core samples having an initial permeability of about 4 mD were used. An aqueous solution containing 20 wt % sodium-GLDA having a pH=3.8 was prepared prior to the fracturing experiments.

Core preparation. Core samples were cut into a parallelepiped shape with the ends curved into half-circles to fit the API cell (American Petroleum Institute). The overall length of the cores was approximately 7 in., with a width of about 1.68 in. and a thickness of about 3 in. Next, the cores were covered with a silicone rubber compound inside a mould of the API cell in order to secure a perfect fit of the core in the cell and to prevent any bypassing of the acid around the sides of the core samples. Subsequently, the cores were placed in a vacuum device for several hours until all air was removed from the pore spaces and then the cores were saturated with tap water.

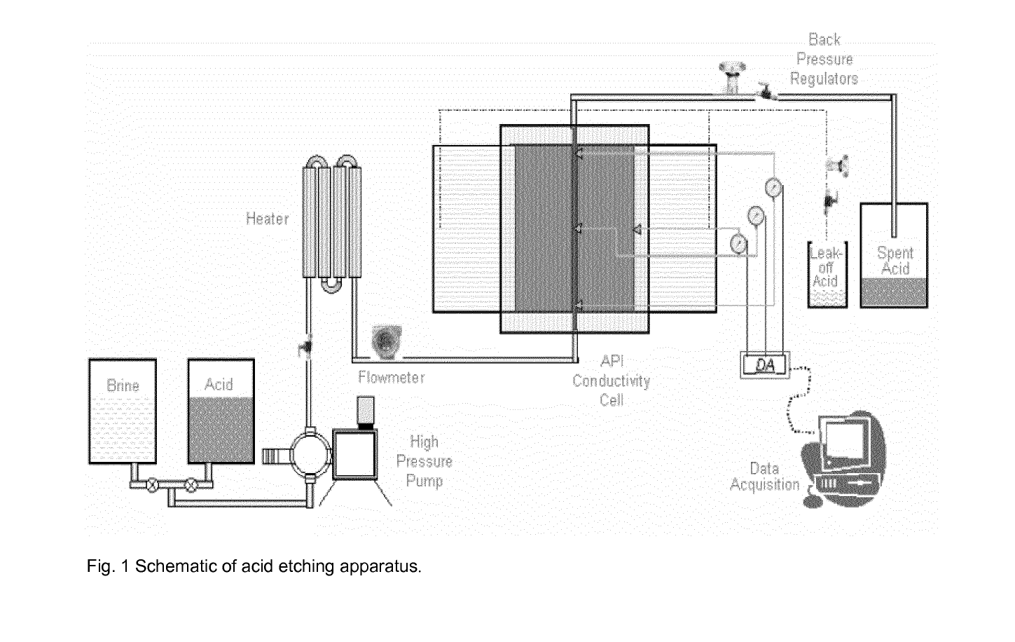

Acid Etching. The acid etching apparatus is shown schematically in FIG. 1. The acid fracture etching experiment involved the following steps: preparation of the GLDA solution described above, placing the cores in the cell, flushing and heating the lines to the desired temperature using tap water flow, and then the actual acidizing process followed by a post-flush with tap water to clean the cores and lines of the acid solution. Cores were fitted in the cell and a fracture gap of about 0.12 in. was maintained, using metallic shims to achieve the desired width. The cell was placed in a vertical direction such that the acid fluids flowed upwards through the fracture to prevent gravity effects on the etching of the core faces. After ensuring that the pistons were in place and the fracture width was maintained at 0.12 in., a pre-flush of tap water was injected. After achieving a cell pressure of 1,000 psi, a leak-off rate of 0.0035 ft/min, and a temperature of 130° F., the GLDA injection was started.

During the GLDA injection, temperature recordings were taken every 2 minutes. The leak-off volume and the leak-off differential pressure were monitored to ensure a 0.0035 ft/min leak-off rate. Finally, after 30 minutes of GLDA injection, tap water was injected to clean the system. The etched surfaces of the cores were photographed and scanned using a profilometer.

Surface Characterization. A profilometer was used to characterize the etched fracture faces after the acid fracturing process. A profilometer is a precise vertical distance measurement device that can measure small surface variations in vertical surface topography as a function of position on the surface. The vertical measurement was made using a laser displacement sensor, while the sample was moved along its length and width on a moving table. A 0.05 in. measurement interval was used in the x and y directions. The resolution on the vertical measurement was 0.002 in., while in the horizontal directions, the transducer resolution was 0.00008 in.

Rock Embedment Strength Measurements. An Instron electric compression test machine was used to determine the rock embedment strength before and after acid injection at 5 evenly spaced points on the surfaces of the core samples. A steel ball was used to indent the surface of the rock and then the embedment pressure was calculated based on the applied load and the projected area:

$${S}_{RE} = \frac{W ( lbs )}{\frac{π {d}_{i}^{2}}{4} ( {in}^{2} )}$$

A steel ball with a diameter of 0.177 in. was used in this study and the indentation distance was specified at around 0.01 in. The initial rock-embedment measurements were taken on the back of the fracture face in order not to affect the acid injection process.

Results and Discussion

Etching Pattern After the contact time of 30 minutes at around 1 L/min injection rate at 130° F., the etched profiles of both fracture faces were analyzed. Great variations in etched depth of the two fracture faces indicated a rather rough pattern with large open flow areas for flow and asperities to hold the flow area open. A rather rough surface could be clearly seen from the core samples after the acidizing process. Due to the low reaction rate of 20 wt % GLDA with calcite at 130° F., more open flow areas and asperities would be expected at high temperatures, since the reaction rate of GLDA increases greatly with the increment of temperature.

Rock Embedment Strength. The change in average rock embedment strength both for face A and face B were summarized in Table 1. Results from both faces show a decreasing trend of rock embedment strength after acid injection ranging from −4.5 to −6.2%. Comparing the results of this experiment with the three state of the art types of HCl systems: gelled, emulsified and with a viscoelastic surfactant for identical Indiana limestone cores as reported in the above-cited SPE 106272, it is clear that GLDA weakens the rock significantly less. After 30 minutes at 200° F. the rock strength of the state of the art HCl based systems was reduced significantly with values ranging from −20 to −45%. The combination of an inhomogeneous etched pattern and the hardness of the asperities created by uneven etching are the critical factor for retaining conductivity after closure. Therefore, when using GLDA for acid fracturing treatments, higher fracture conductivity will be created after closure because the asperities are harder to crush in comparison of the ones acidized with known HCl based systems.

TABLE 1
Comparison of Average Rock Embedment Strength
before and after GLDA (pH 3.8) injection

| | | | | Rock Embedment Strength | | |
|---|---|---|---|---|---|---|
| | | Time | Temperature | Before | After | % |
| Label | Acid | (minute) | (° F.) | (psi) | (psi) | change |
| Face A | GLDA | 30 | 130 | 38,516 | 36,139 | −6.2 |
| Face B | GLDA | 30 | 130 | 37,705 | 36,013 | −4.5 |

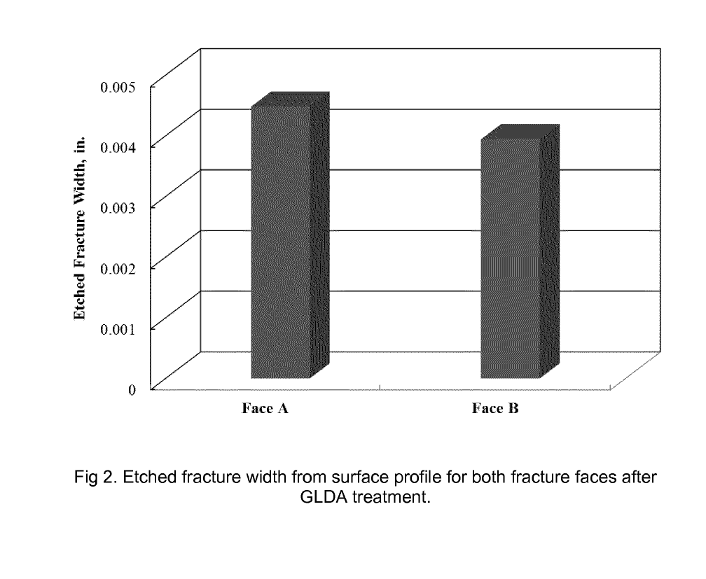

Etched width. Based on the etching pattern analysis, the etched fracture surface volume was calculated from the difference in surface volume between the before and after acidizing samples. From the etched surface, width was calculated using the cross-sectional area of the fracture (FIG. 2). It was noted that there are similar etched widths on both fracture faces after treatment with GLDA.

Based on the Results Obtained, the Following Conclusions can be Drawn:

20 wt % GLDA resulted in rather rough etched patterns and relatively high asperities on low permeability Indiana limestone cores while showing a large improvement in reducing the undesired weakening or softening of the rock formations that find place during acid fracturing processes, when compared to state of the art HCl based systems.

Due the relatively low reaction rate of GLDA with calcite at 130° F., more etched patterns and asperities would be expected at high temperatures based on the results obtained in this experiment and the fact that the reaction rate of GLDA with calcite increases greatly as the temperature increases.

1. A process for fracturing a subterranean formation comprising a step of fracturing the formation and a step of introducing a treatment fluid containing glutamic acid N,N-diacetic acid or a salt thereof (GLDA), methylglycine N,N-diacetic acid or a salt thereof (MGDA) and/or N-hydroxyethyl ethylenediamine N,N′,N′-triacetic acid or a salt thereof (HEDTA) into the formation, wherein the fracturing step can take place before introducing the treatment fluid into the formation, while introducing the treatment fluid into the formation or subsequent to introducing the treatment fluid into the formation, the treatment fluid is allowed to contact the surfaces of the subterranean formation in the fractured zones, to change at least part of these surfaces, to create an inhomogeneous fracture surface, to remove small particles and fines from the fractures, and/or to prevent the fractures from completely closing immediately when the fracture pressure is released to achieve at least one of (i) an increased permeability or conductivity, (ii) the removal of small particles, and (iii) the removal of inorganic scale, and so ultimately enhance the well performance and enable an increased production of oil and/or gas from the fractured formation, and the treatment fluid contains between 5 and 30 wt % of GLDA, MGDA and/or HEDTA based on the total fluid weight.

2. The process of claim 1, wherein the treatment fluid containing glutamic acid N,N-diacetic acid or a salt thereof (GLDA), methylglycine N,N-diacetic acid or a salt thereof (MGDA) and/or N-hydroxyethyl ethylenediamine N,N′,N′-triacetic acid or a salt thereof (HEDTA) is also the fracturing fluid.

3. The process of claim 1, wherein the treatment fluid contains GLDA.

4. The process of claim 1, wherein the subterranean formation is a carbonate formation or a carbonate-containing formation.

5. The process of claim 1, wherein the treatment fluid has a pH of between 3 and 13.

6. The process of claim 5, wherein the treatment fluid has a pH of between 3 and 6.

7. The process of claim 1, wherein the process is done at a temperature of between 77 and 300° F. (about 25 and 149° C.).

8. The process of claim 1, wherein the treatment fluid contains water as a solvent.

9. The process of claim 1, wherein the treatment fluid in addition contains a further additive selected from the group consisting of anti-sludge agents, surfactants, corrosion inhibitors, mutual solvents, corrosion inhibitor intensifiers, foaming agents, viscosifiers, wetting agents, diverting agents, oxygen scavengers, carrier fluids, fluid loss additives, friction reducers, stabilizers, rheology modifiers, gelling agents, scale inhibitors, breakers, salts, brines, pH control additives, bactericides/biocides, particulates, crosslinkers, salt substitutes, relative permeability modifiers, sulfide scavengers, fibres, nanoparticles, and consolidating agents.

10. The process of claim 9, wherein the surfactant is present in an amount of 0.1 to 2 volume % on total fluid volume.

11. The process of claim 9, wherein the corrosion inhibitor is present in an amount of 0.01 to 2 volume % on total fluid volume.

12. The process of claim 1, wherein the mutual solvent is present in an amount of 1 to 50 wt % on total fluid weight.

13. The process of claim 3, wherein the pH is between 3 and 6.
